(19) United States
(12) Patent Application Publication
(10) Pub. No.: US 2012/0313741 A1
(43) Pub. Date: Dec. 13, 2012

(54) Data Transmission Apparatus Comprising a Helically Wound Conductor

(76) Inventors: David R. Hall, Provo, UT (US); Scott Dahlgren, Alpine, UT (US); Jonathan Marshall, Provo, UT (US)

(21) Appl. No.: 13/157,279

(22) Filed: Jun. 9, 2011

(51) Int. Cl. H01F 21/04

(52) U.S. Cl. 336/118

(57) ABSTRACT

In one aspect of the present invention, an inductive coupling comprises an inner and outer casing. The inner casing comprises an inner trough formed into an exterior surface with an inner electrical conductor disposed within the inner trough. The outer casing comprises an outer trough formed into the interior surface with an outer electrical conductor disposed within the outer trough. The outer casing is configured to encircle the inner casing such that the inner electrical conductor is in magnetic communication with the outer electrical conductor. A helical geometry is formed in at least one of the inner or outer troughs. The inner and outer casings are configured to move relative to each other.

### BACKGROUND OF THE INVENTION

This invention relates to the field of data transmission. More specifically, it relates to the field of translatable downhole data transmission apparatuses.

U.S. Pat. No. 6,540,032 to Krueger, which is herein incorporated by reference for all that is contains, discloses an apparatus for power and data transfer over a gap between rotating and non-rotating members of downhole oilfield tools by means of an inductive coupling. An electronic control circuit associated with the rotating member controls the transfer of power and data from the rotating member to the non-rotating member.

U.S. Pat. No. 6,670,880 to Hall, et al., which is herein incorporated by reference for all that is contains, discloses a system for transmitting data through a string of downhole components. A varying current applied to a first electrically conducting coil in one component generates a varying magnetic field in a first magnetically conductive, electrically insulating element, which varying magnetic field is conducted to and thereby produces a varying magnetic field in a second magnetically conductive, electrically insulating element of a connected component, which magnetic field thereby generates a varying electrical current in a second coil in the connected component.

U.S. Pat. No. 7,268,697 to Hall, et al., which is herein incorporated by reference for all that is contains, discloses A data transmission apparatus having first and second electrical conductors is disclosed. The first and second electrical conductors are disposed within recesses of a first and second complementary surfaces that are magnetically conducting and electrically insulating. The first and second surfaces are in close proximity to each other. The first surface is translatable along the length of the second surface. The first and second electrical conductors are in electromagnetic communication and provide for the transmission of data or power from the first electrical conductor to the second electrical conductor as the first surface overlaps the second surface. The data transmission apparatus may be located in one or more downhole tools.

U.S. Pat. No. 7,193,527 to Hall, et al., which is herein incorporated by reference for all that is contains, discloses a swivel assembly for a downhole tool string comprises a first and second coaxial housing cooperatively arranged. The first housing comprises a first transmission element in communication with surface equipment. The second housing comprises a second transmission element in communication with the first transmission element. The second housing further comprises a third transmission element adapted for communication with a network integrated into the downhole tool string. The second housing may be rotational and adapted to transmit a signal between the downhole network and the first housing. Electronic circuitry is in communication with at least one of the transmission elements. The electronic circuitry may be externally mounted to the first or second housing. Further, the electronic circuitry may be internally mounted in the second housing. The electronic circuitry may be disposed in a recess in either first or second housing of the swivel.

### BRIEF SUMMARY OF THE INVENTION

In one aspect of the present invention, an inductive coupling comprises an inner and outer casing. The inner casing comprises an inner trough formed into an exterior surface with an inner electrical conductor disposed within the inner trough. The outer casing comprises an outer trough formed into the interior surface with an outer electrical conductor disposed within the outer trough. The outer casing is configured to encircle the inner casing such that the inner electrical conductor is in magnetic communication with the outer electrical conductor. A helical geometry is formed in at least one of the inner or outer troughs. The inner and outer casings are configured to move relative to each other.

The inner and outer casing may be configured to translate axially or rotate with respect to each other. When the inner or outer casing translates or rotates, a surface overlap between the inner and outer conductor may remain constant.

The inner and/or the outer troughs may comprise an electrically insulating, magnetically conducting material configured to direct a magnetic field formed from the inner and/or outer electrical conductor towards the adjacent conductor. The electrically insulating, magnetically conducting material may be U-shaped.

In some embodiments, the inner electrical conductor is wired by first, entering the inner trough from a proximal end, second, following a length of the inner trough, third, entering a port at a distal end leading towards inside the inner casing, forth, traveling within the inner casing, and fifth, reentering at the proximal end of the inner trough.

Either the inner or the outer casing may form a toroidal geometry. The toroidal geometry may comprise a plurality of electrically independent axially spaced toroidal segments that are spaced axially with respect to each other. The segments may be electrically independent of each other, or at least some of the segments may be in electrically communication.

The electrical conductors may be configured to transfer power and/or data. A plurality of sensors or other devices requiring power may be in electrical communication with one of the conductors. The sensors or other devices may be configured to receive power from the power source through the inductive coupling.

In some embodiments, part of the coupling is connected to a reamer or other tool with movable parts. When a reamer blade expands or contracts, the reamer may translate a mechanical member within a tool string, and the mechanical member may be in mechanical communication with the inner or outer casing. In some embodiments, the outer casing is firmly affixed to an inner circumference of the mechanical member and configured to translate along an axis of a tool string component. An attachment end of the inner casing may be rigidly attached to a fixed member such that the inner casing is in communication with the outer casing. The outer casing may also be in electrical communication with surface equipment.

### BRIEF DESCRIPTION OF THE DRAWINGS

FIG. 1 is a perspective view of an embodiment of a drill string.

FIG. 2a is a perspective view of an embodiment of an expandable tool.

FIG. 2b is a perspective view of an embodiment of an expandable tool.

FIG. 3a is a cross-sectional view of an embodiment of an expandable tool.

FIG. 3b is a cross-sectional view of another embodiment of an expandable tool.

FIG. 4a is a cross-sectional view of an embodiment of a helical coupler.

FIG. 4b is a cross-sectional view of another embodiment of a helical coupler.

FIG. 5a is a perspective view of another embodiment of a helical coupler.

FIG. 5b is a cross sectional view of an embodiment of a coupling.

FIG. 6 is an exploded view of an embodiment of a trough.

FIG. 7a is a cross-sectional view of another embodiment of a helical coupler.

FIG. 7b is a cross-sectional view of another embodiment of a helical coupler.

FIG. 8a is a cross-sectional view of another embodiment of a helical coupler.

FIG. 8b is a cross-sectional view of another embodiment of a helical coupler.

FIG. 9 is a cross-sectional view of another embodiment of a helical coupler.

### DETAILED DESCRIPTION OF THE INVENTION AND THE PREFERRED EMBODIMENT

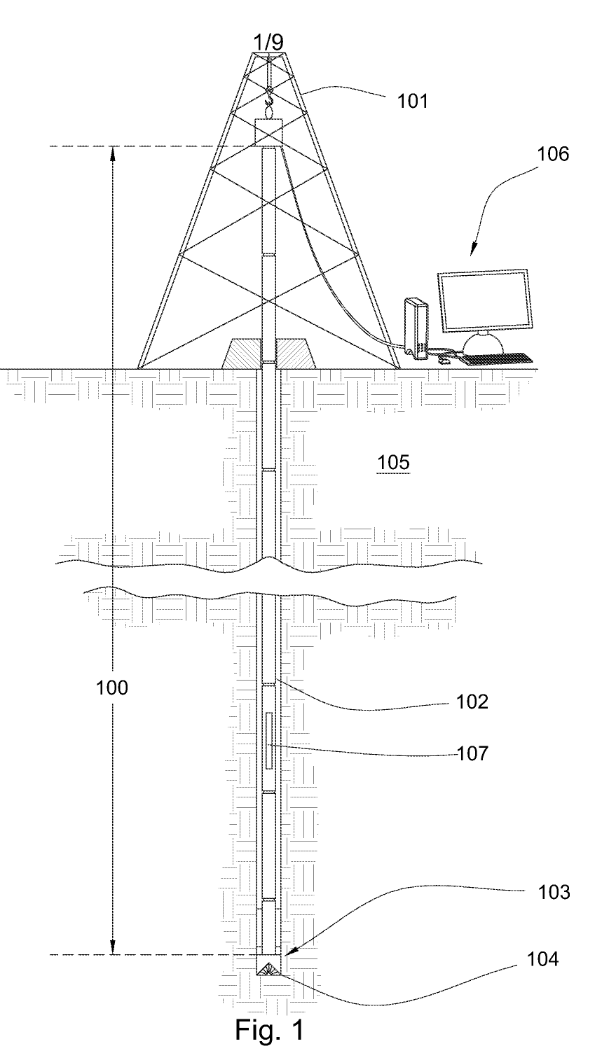

FIG. 1 discloses an embodiment of a drilling operation comprising a drilling derrick 101 supporting a drill string 100 inside a borehole 102. The drill string 100 may comprise a bottom hole assembly 103 that includes electronic equipment and an expandable tool 107. The expandable tool 107 may be configured to rotate in the borehole 102. Rotating the drill string 100 may also rotate a drill bit 104 and cause the drill bit 104 to degrade a bottom of the borehole 102. The expandable tool 107 may ream a larger diameter in the borehole 102 than formed by the drill bit 104. In some embodiments, the expandable tool 107 may be configured to limit drilling vibrations by stabilizing the drill string 100. Information may be sent to and from the expandable tool 107 and/or bottom hole assembly 103 to electronic equipment 106.

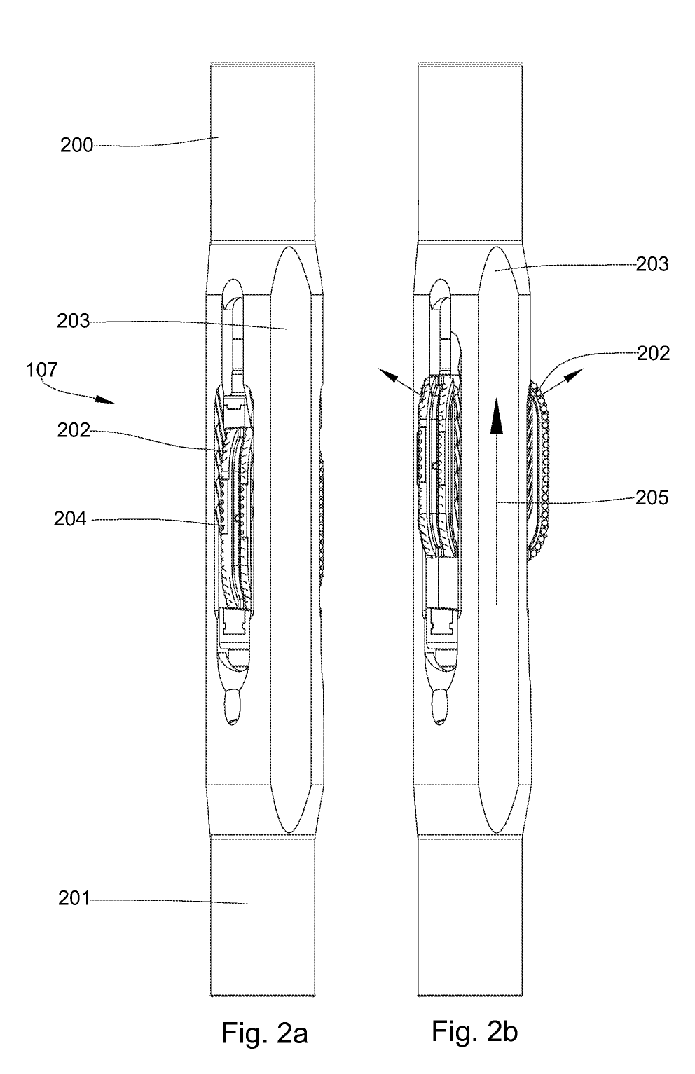

FIG. 2a discloses an embodiment of the expandable tool 107. A proximal end 200 of the expandable tool 107 may connect other downhole tool string components at tool joints. A distal end 201 of the tool may connect directly the bottom hole assembly 103, drill bit 104, or other drill string components. In this embodiment, the expandable tool 107 may comprise a mandrel with a tubular body and an outer surface, a plurality of blades 202 disposed around the mandrel's outer surface, and a slidable sleeve 203.

The slidable sleeve 203 comprises the plurality of blades 202 disposed in slots formed in the thickness of the sleeve's wall. A plurality of axial segments may form the slidable sleeve 203. The plurality of blades 202 may comprise a plurality of cutting elements 204 and may be configured to ream the borehole wall 102. The blades 202 of FIG. 2a are in a retracted position.

FIG. 2b discloses the slidable sleeve 203 configured to slide along an outer diameter of the expandable tool 107. The slidable sleeve 203 and the plurality of blades 202 may be connected such that as the slidable sleeve 203 slides along the expandable tool 107 in the direction of arrow 205, the plurality of blades 202 shifts laterally out of the slot. Sliding the sleeve 203 in the reverse direction may result in retracting the expandable tool 107. When the plurality of blades 202 is in an expanded position it may become engaged with a bore wall of an earthen formation 105.

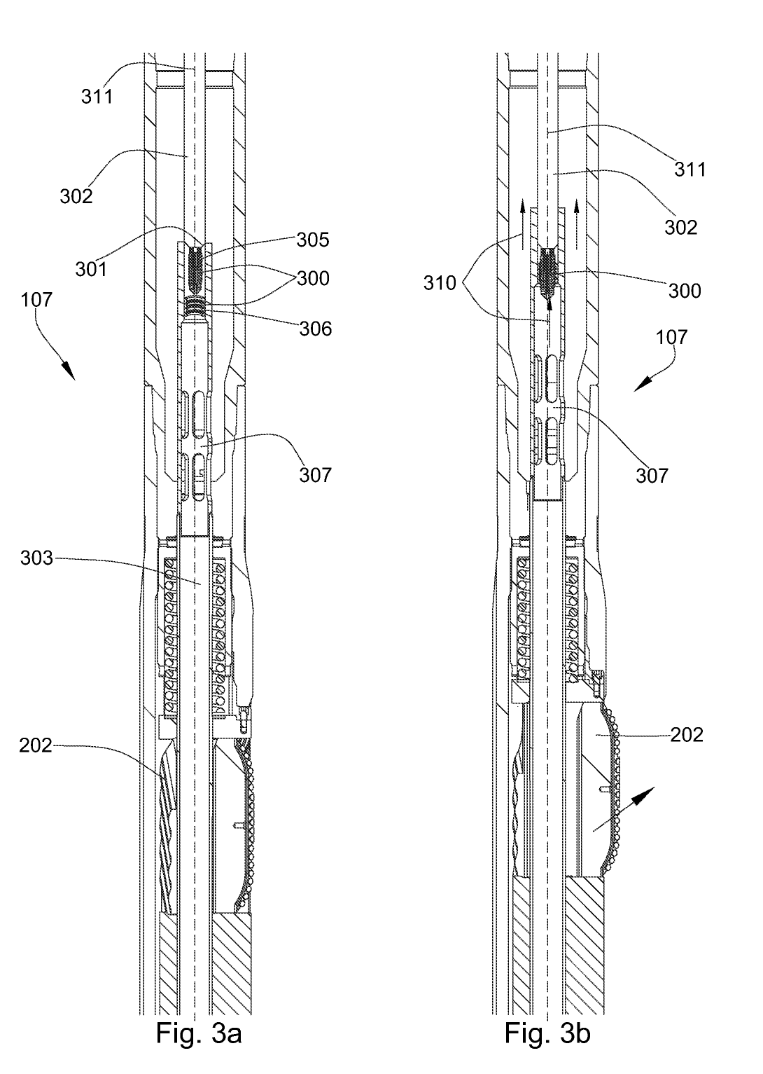

FIG. 3a discloses an embodiment of the expandable tool 107 comprising an inductive coupling 300 disposed within a bore 303 of the tool 107. The coupling 300 may be configured to pass a signal from the expandable tool 107 to surface equipment. An outer casing 306 and an inner casing 305 may form part of the coupling 300. The inner casing may comprise an attachment end 301 that is configured to attach to a fixed member 302 secured within the tool string component's bore. The fixed member 302 may hold the inner casing 305 relatively stationary within the bore 303. The expandable tool 107 may comprise a linear actuator 307 disposed near an axis 311 of the component. The outer casing 306 may be formed into a distal end 304 of the linear actuator 307.

FIG. 3b discloses another embodiment of the expandable tool 107 and the inductive coupling 300. Axes of the inner and outer casings 305, 306 may be substantially aligned. The linear actuator 307 may be configured to move along a length of the tool component and cause the outer casing 306 to encircle the inner casing 305. Once encircled, the inner and outer conductors may overlap, and the conductors may form a magnetic circuit that may transfer power and/or data back and forth.

Arrows 310 depict movement of the linear actuator 307, which may move along the axis 311 of the tool string component as the reamer blade 202 extends or retracts. The movement of the actuator may be proportional to the movement of the blades, thus, determining the position of the actuator through the coupling will indicate the position of the blades.

A fixed member 302 may be substantially fixed within the bore 303 and comprise an attachment end 301 that supports the inner casing 305. The inner casing 305 may be in electrical communication with the surface equipment through the fixed member. The surface equipment may send commands and/or power to the expandable tool 107 and/or down hole assembly. These signals may be passed through the coupling. Further, inductive or direct couplings may be located in each tool joint of the tool string. Inductive couplers that may be compatible with the present invention are described in U.S. Pat. No. 6,770,880, which is herein incorporated by reference for all that it discloses.

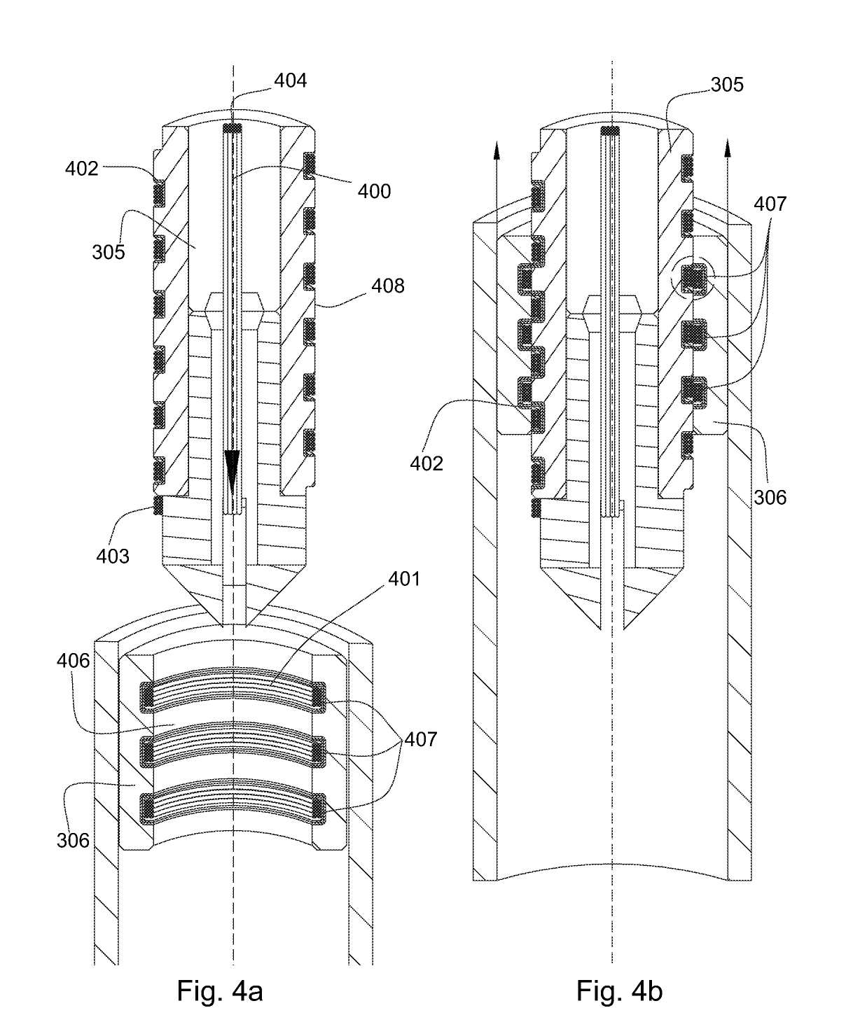

FIGS. 4a and b disclose embodiments of the inner and outer casings 305, 306. A trough may be formed in the inner and outer casings 305, 306 and be configured to hold an inner and outer electrical conductor 400, 401, respectively. An electrically insulating, magnetically conducting (EIMC) material 402 may line at least a portion of the trough. The EIMC material may be substantially U-shaped and configured to housing the inner and outer electrical conductors 400, 401. As an electrical signal travels along either the first or second electrical conductor, the resulting magnetic field may radiate outward from the conductor. However, the EIMC material 402 may provide a magnetic path of least resistance, which may direct the field towards the other conductor. As the other conductor is influenced by the magnetic field, a resulting electrical signal is generated in the other conductor, thus, the signal is passed inductive from one conductor to the other. The EIMC material 402 may support the inner and outer electrical conductors 400, 401. The EIMC material 402 may prevent the electrical signal from shorting to the inner and/or outer casing 305, 306.

The inner and outer electrical conductors 400, 401 may be configured to carry the electrical signal from the surface equipment to the 106 expandable tool 107. The inner electrical conductor 400 may enter an inner trough from an end 403 of the inner casing. The electrical conductor 400 may then follow the inner trough. After following the inner trough, the electrical conductor 400 may enter the inner casing through a port 404 leading toward an axis of the inner casing 305. The conductor 400 may travel along a length of the inner casing 305 and reenter the inner trough. The conductor 400 may then repeat the process for form several windings. The conductor 400 disposed within the inner casing 305 may comprise a single wire continually wrapped in the manner just described or in another manner.

The outer electrical conductor 401 may be toroidally wound into an interior surface 406 of the external casing. Each toroidal segment 407 may be wound by a single continuous wire.

The inner trough may be configured to face the outer casing while the outer trough is configured to face the inner casing. This configuration may ensure that the troughs face each other and may form a magnetic circuit with each other. It is believed that the more overlap between the inner and outer conductors, the more signal strength will be passed through the coupling. However, the present invention is believed to provide power and/or data transfer in applications where the components of the coupling move significant amounts, and significant overlap over the range that the components may move is not feasible. Thus, the present invention allows some overlap to be maintained while accommodating significant movement of the coupling's components.

In some embodiments, the coupling may be arranged to be a sensor. Here, the toroidal troughs 407 formed in the outer casing 306 may be electrically independent of each other and connected to independent current and/or voltage measuring mechanisms. These mechanisms may be configured to send their measurements to a centralized processor that may determine with toroids are in magnetic communication with the inner casing 305. The tool 107 may be configured such that as the blade 202 extends, the inner and outer casings overlap more causing more toroidal windings 407 to be in magnetic communication with the helical windings. Thus, the extension depth of the expandable tool's blades may be determined.

In some embodiments the coupling may be configured to transfer power. Thus, fewer downhole power sources may be required because a single power source may be used to power electrically dependant instruments on both sides of the coupling.

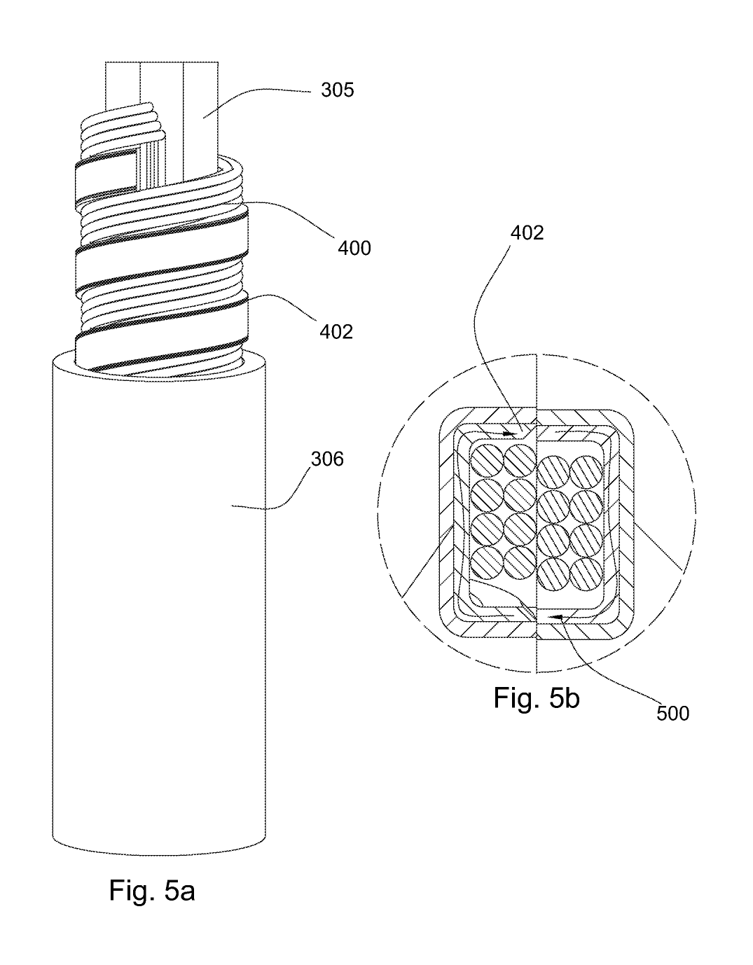

FIG. 5a discloses the inner casing 305 set into the outer casing 306 and forming the coupling 300. The inner casing 305 comprises a helically wound conductor 400 formed into the exterior surface 408 of the inner casing 305. The helically wound conductor 400 may ensure an substantially constant communication between the inner and outer casings 305, 306 during operation.

The inner casing 305 may comprise a helically wound conductor 305 while the outer coupler 306 comprises a toroidally wound conductor 401 causing the inner conductor 400 to overlap with the outer conductor 401. The helically wound inner conductor 400 may overlap the toroidally wound outer conductor 401 at several locations. As the casings 305, 306 move, relative to each other, the helically wound conductor 400 disposed within the inner casing 305 may ensure a similar percentage of the outer conductors surface will remain overlapped throughout operations. This overlap may allow the coupling 400 to retain a similar signal strength while moving.

FIG. 5b discloses the magnetic field 500 created in the EIMC material 402. The electrical signal passing through one conductor creates the magnetic field 500 in the trough surrounding that conductor. When the EIMC materials 402 are in close proximity, the magnetic field 500 may be directed into the adjacent trough's material.

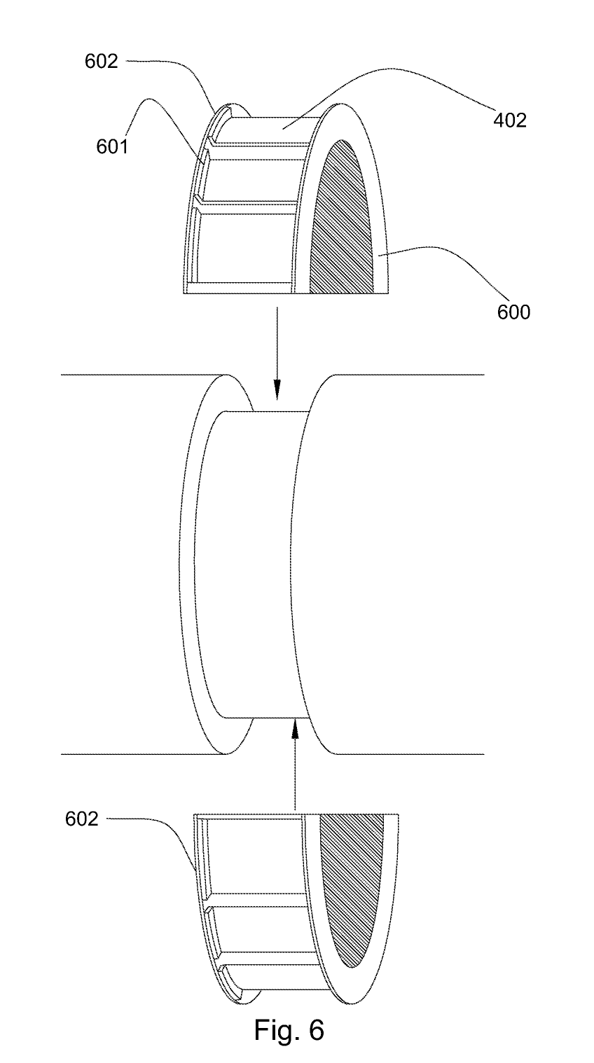

FIG. 6 discloses a ring 600 comprising the segment segments of the EIMC material 402. The ring 600 may be configured to the EIMC material, which may be fragil. The ring 600 and the segmented material 402 may be configured such that an end 601 of the material's U-shape may be substantially flush with an end of the trough 602. In some embodiments, a helical ring may be formed to fit into helically shaped troughs.

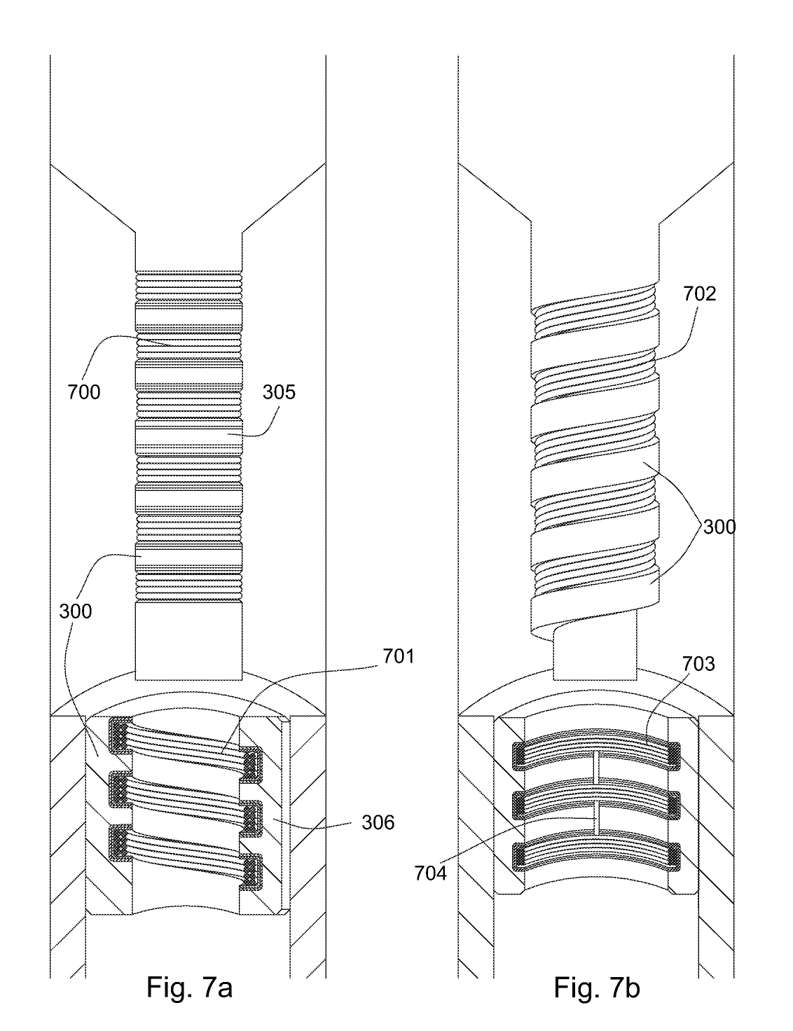

FIG. 7a discloses the coupling 300 comprising a toroidally wound conductor 700 formed in the inner casing 305 and a helically wound conductor 701 formed into the outer casing 306.

FIG. 7b discloses the coupling 300 comprising a helically wound conductor 702 formed in the inner casing 305 and a toroidally wound conductor 703 formed into the outer casing 306. The toroidally wound electrical conductor 703 may be electrically connected by means of a wire 704 connecting the toroidal segments. The wire 704 may connect the conductors 703 in series. This may allow the signal strength to be increased as the toroidal segments are in electrical communication, each segment adding to the strength of a passed signal.

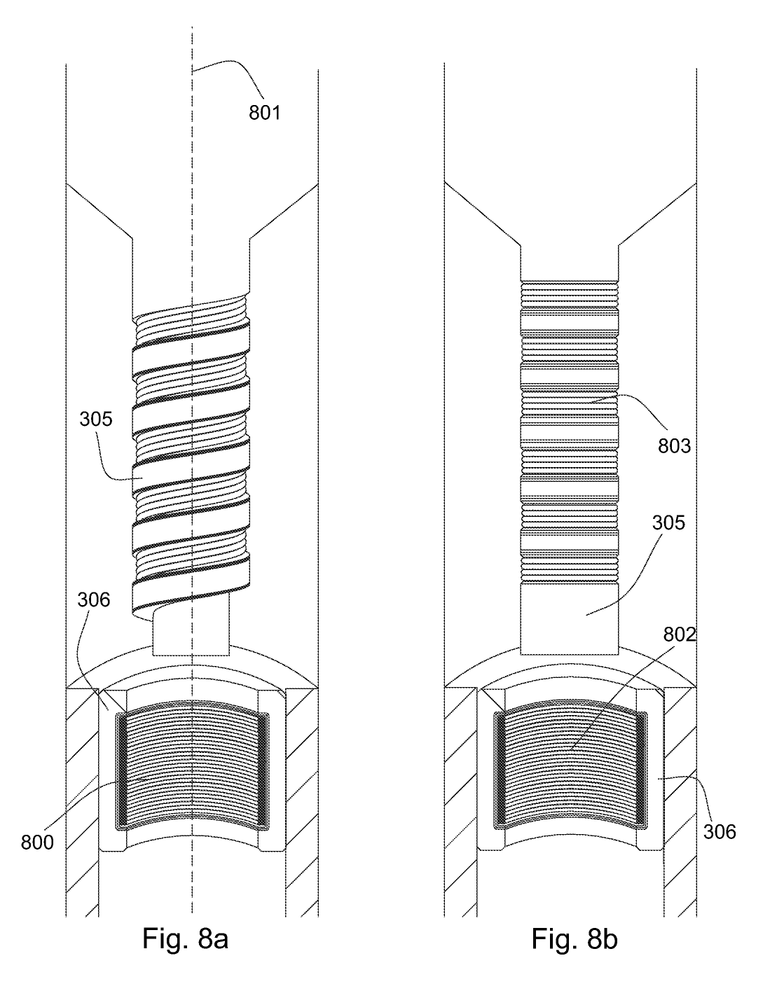

FIG. 8a discloses the outer casing 306 comprising a single toroidal trough 800. This embodiment may be configured to send the signal through the inner casing 305 to the outer casing 306. The elongated trough 800 and increased receiving area in the outer casing 306 may increase the signal strength. As the inner casing 305 translates along the axis 801 or rotates about the axis 801, the signal passed from the inner casing 305 to the outer casing 306 may lose little strength as the receiving area 800 on the outer casing 306 is elongated.

FIG. 8b discloses a single helical trough 802 formed in the outer casing 306. The helically wound conductors in the trough 802 may result in a strong connection between the toroidally wound conductors 803 in the inner casing 305 and the helical conductor 802 in the outer casing 306.

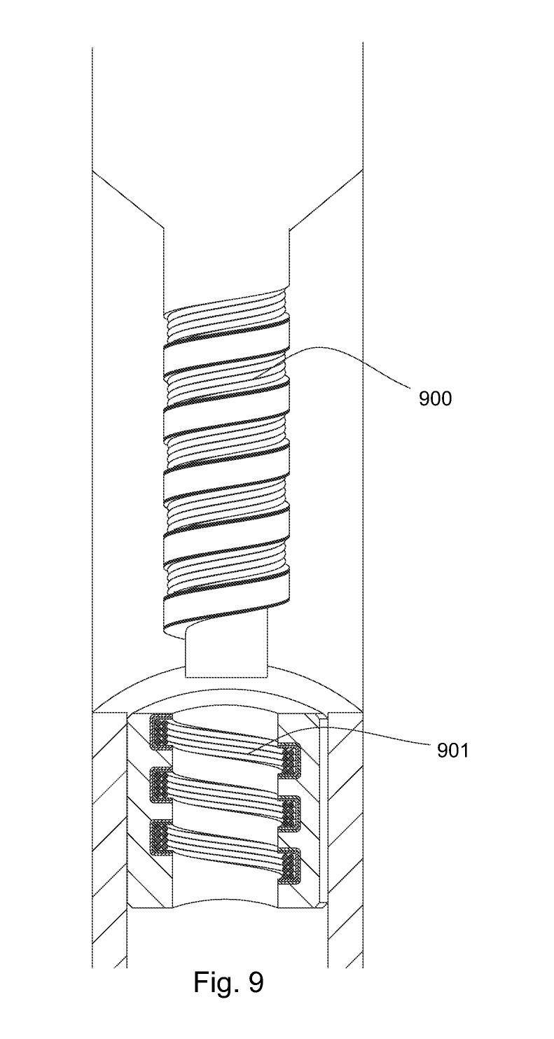

FIG. 9 discloses helical troughs 900, 901 formed into the inner and outer casings 305, 306. This may ensure a continued magnetic connection between the two casings 305, 306.

Whereas the present invention has been described in particular relation to the drawings attached hereto, it should be understood that other and further modifications apart from those shown or suggested herein, may be made within the scope and spirit of the present invention.

What is claimed is:

1. An inductive coupling, comprising;
an inner casing comprising an inner trough formed into an exterior surface;
an inner electrical conductor disposed within the inner trough;
an outer casing comprising an outer trough formed into an interior surface;
an outer electrical conductor disposed within the outer trough;
the outer casing configured to encircle the inner casing such that the inner electrical conductor is in magnetic communication with the outer electrical conductor;
at least one of the inner or outer troughs comprise a helical geometry; and
the inner and outer casings are configured to move relative to each other.

2. The coupling of claim 1, wherein either the inner or outer trough form a toroidal geometry.

3. The coupling of claim 2, wherein the toroidal geometry comprises a plurality of electrically independent axially spaced toroidal segments.

4. The coupling of claim 3, wherein each electrically independent toroidal segment is in independent electrical communication with distinguishable electrical output readers.

5. The coupling of claim 2, wherein the toroidal geometry comprises a plurality of axially spaced toroidal segments in electrically communication with each other.

6. The coupling of claim 1, wherein the inner and outer casing are configured to translate axially with respect to each other.

7. The coupling of claim 1, wherein when the inner and outer casing axially translated or rotated with respect to each other, a surface overlap between the inner and outer conductor remains constant.

8. The coupling of claim 1, wherein the inner and outer casing are configured to rotate with respect to each other.

9. The coupling of claim 1, wherein the inner and outer troughs comprise an electrically insulating, magnetically conducting material configured to direct a magnetic field formed from the inner and/or outer electrical conductor toward the adjacent conductor.

10. The coupling of claim 9, wherein the electrically insulating, magnetically conducting material is generally U-shaped.

11. The coupling of claim 1, wherein expanding and/or contracting a reamer translates a mechanical member within a tool string, wherein the mechanical member is in mechanical communication with the inner or outer casing.

12. The coupling of claim 11, wherein the outer casing is firmly affixed to an inner circumference of the mechanical member and configured to translate along an axis of a tool string component.

13. The coupling of claim 11, wherein an attachment end of the inner casing is rigidly attached to a fixed member, wherein the inner casing is in communication with the outer casing.

14. The coupling of claim 11, wherein the outer casing is in electrical communication with surface equipment.

15. The coupling of claim 1, wherein the electrical conductors are configured to transfer power.

16. The coupling of claim 1, wherein a plurality of sensors in electrical communication with inner conductor is configured to receive power from a power source in electrical communication with the outer conductor.

17. The coupling of claim 1, wherein a plurality of sensors in electrical communication with outer conductor is configured to receive power from a power source in electrical communication with the inner conductor.

18. The coupling of claim 1, wherein the inner electrical conductor enters the inner trough from a proximal end, follows a length of the inner trough, enters a port at a distal end leading toward inside the inner casing, travels within the inner casing, and reenters at the proximal end of the inner trough.

19. The coupling of claim 1, wherein the inner and outer trough are electrically insulating.

20. The coupling of claim 1, wherein the inner and outer troughs are spring loaded to contact one another.
